(19) United States
(12) Patent Application Publication
(10) Pub. No.: US 2009/0222752 A1
(43) Pub. Date: Sep. 3, 2009

(54) INDUSTRIAL AUTOMATION VISUALIZATION OBJECT HAVING INTEGRATED HMI AND CONTROL COMPONENTS

(76) Inventors: Brian Alexander Wall, White Rock (CA); Kevin George Gordon, Vancouver (CA); Mark David Hobbs, Hartford, WI (US); Mohamed Salehmohamed, Surrey (CA)

Correspondence Address: Setter Roche LLP, Suite A, 515 Briggs Street, Erie, CO, 80516, US

(21) Appl. No.: 12/041,541

(22) Filed: Mar. 3, 2008

(51) Int. Cl. G06F 3/048; G05B 15/02; G06F 17/30

(52) U.S. Cl. 715/771; 700/87; 707/104.1; 707/E17.001

(57) ABSTRACT

In order to update control and visualization configurations in an industrial automation environment, a method is performed including the operations of; receiving a single software object containing machine configuration information related to a new machine attribute, updating a visualization configuration with a new visualization attribute corresponding to the new machine attribute, and updating a control configuration with a new control attribute corresponding to the new machine attribute.

### TECHNICAL FIELD

This disclosure is related to the field of factory automation, and in particular, to the updating of control and visualization configurations in an industrial automation environment.

### TECHNICAL BACKGROUND

Industrial processes, such as petroleum refining, water treatment, materials manufacturing, and the like, are increasingly automated and often require constant monitoring of one or more process variables to ensure the process is performing as expected or desired. Often these process variables are monitored from a location remote from the machines controlling the process. One computer may be used as a human-machine interface (HMI) monitoring and controlling the process, while a different computer is used to directly control the industrial machines. These separate computers may be connected through a local area network (LAN) or other network configuration.

When changes to the machinery occur, models of the machinery in both the HMI and the control computers must be updated to take advantage of the new attribute of the machine. If the two computers are not updated in a manner consistent with each other, they will not be able to interface correctly with each other, and the automation system will not function properly. Current automation systems require one or more users to update separate machine models on the HMI computer and the control computer. If these updates are not equivalent, the two computers will not be able to operate correctly together. In some environments, two different users are responsible for the separate computers, further increasing the likelihood of mismatched models.

### TECHNICAL SUMMARY

In this regard, systems and methods for updating control and visualization configurations in an industrial automation environment are provided. An exemplary embodiment of such a method comprises; receiving a single software object containing machine configuration information related to a new machine attribute, updating a visualization configuration with a new visualization attribute corresponding to the new machine attribute, and updating a control configuration with a new control attribute corresponding to the new machine attribute.

An exemplary embodiment of a system comprises a storage system containing software, and a processing system coupled to the storage system. The processing system is instructed by the software to receive a single software object containing machine configuration information related to a new machine attribute, update a visualization configuration with a new visualization attribute corresponding to the new machine attribute, and update a control configuration with a new control attribute corresponding to the new machine attribute.

An exemplary embodiment of a computer-readable medium of instructions for updating control and visualization configurations in an industrial automation environment comprises receiving a single software object containing machine configuration information related to a new machine attribute, updating a visualization configuration with a new visualization attribute corresponding to the new machine attribute, and updating a control configuration with a new control attribute corresponding to the new machine attribute.

Other systems, methods, features and/or advantages of this disclosure will be or may become apparent to one with skill in the art upon examination of the following drawings and detailed description. It is intended that all such additional systems, methods, features and/or advantages be included within this description and be within the scope of the present disclosure

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, there is no intent to limit the disclosure to the embodiment or embodiments disclosed herein. On the contrary, the intent is to cover all alternatives, modifications, and equivalents.

FIG. 1 is a block diagram of an automation system according to an embodiment of the invention.

FIG. 2 is a flowchart of a method for updating control and visualization configurations in an industrial automation environment according to an embodiment of the invention.

FIG. 3 is a block diagram of an automation system according to an embodiment of the invention.

FIG. 4 is a block diagram of an automation system according to an embodiment of the invention.

FIG. 5 is a flowchart of a method for updating an automation system according to an embodiment of the invention.

FIG. 6 is a block diagram illustrating a computer system in an embodiment of the invention.

### DETAILED DESCRIPTION

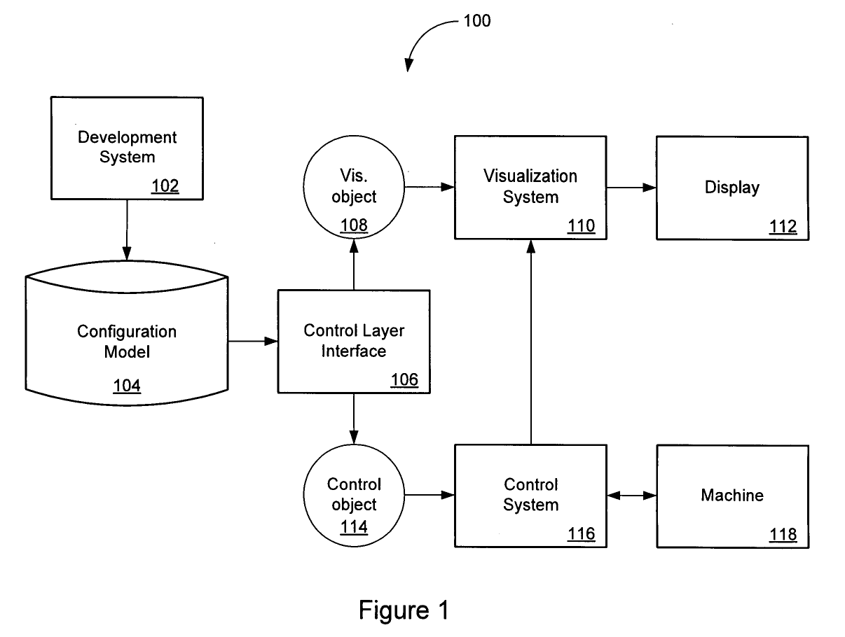

FIG. 1 is a block diagram of an automation system according to an embodiment of the invention. In this example embodiment of an automation system 100, a development system 102 is used to create a configuration model 104 containing machine configuration information related to a new machine attribute. This configuration model 104 contains the necessary configuration information required to update both a visualization system 110 and a control system 116. The visualization computer 110 in this embodiment acts as a human-machine interface (HMI). The control system 116 is used to control a machine 118 in an automation environment 100. A control layer interface 106 receives the configuration model 104 from the development system 102 and creates a visualization object 108 and a control object 114 from the data in the configuration model 104. The configuration model 104 is created by a user such that it contains configuration information for both the visualization system 110 and the control system 116. This model 104 may take the form of a single software object which is split into a visualization object 108 and a control object 114 by the control layer interface 106. For example, if a user wishes to update how a pump is controlled and displayed in an automation environment by adding another measured feature of the pump (such as temperature), the user creates a configuration model 104 containing information necessary for the control computer 116 to receive temperature information from the pump. The configuration model 104 also contains configuration information necessary for the visualization system 110 to display the temperature information from the pump on a display 112. Since a single configuration model 104 is used to update both the control system 116 and the visualization system 110, errors due to incompatible models in the two systems are reduced.

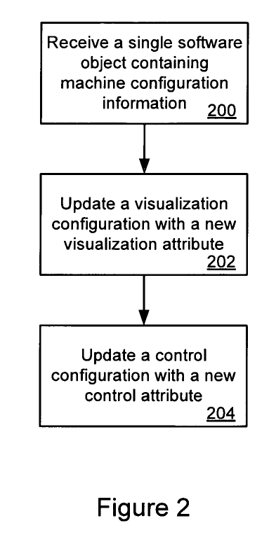

FIG. 2 is a flowchart of a method for updating control and visualization configurations in an industrial automation environment in an embodiment of the invention. In an operation 200, a single software object containing machine configuration information is received. This software object is a single computer software file containing instruction code related to machine configurations in an industrial automation environment. Those of skill in the art will recognize that there exists a very wide variety of possible machine configuration information and a wide variety of methods to create a single software object containing machine configuration information all within the scope of the present invention. In an operation 202, a visualization configuration is updated with a new visualization attribute. The visualization configuration is used by a visualization system to configure a display with graphical representations of machine parameters received from a control system. In an operation 204, a control configuration is updated with a new control attribute. The control configuration is used by a control system to control one or more mechanical elements in an automated industrial environment, and to receive monitoring data from the mechanical elements, and transfer the monitoring data to the visualization system for display.

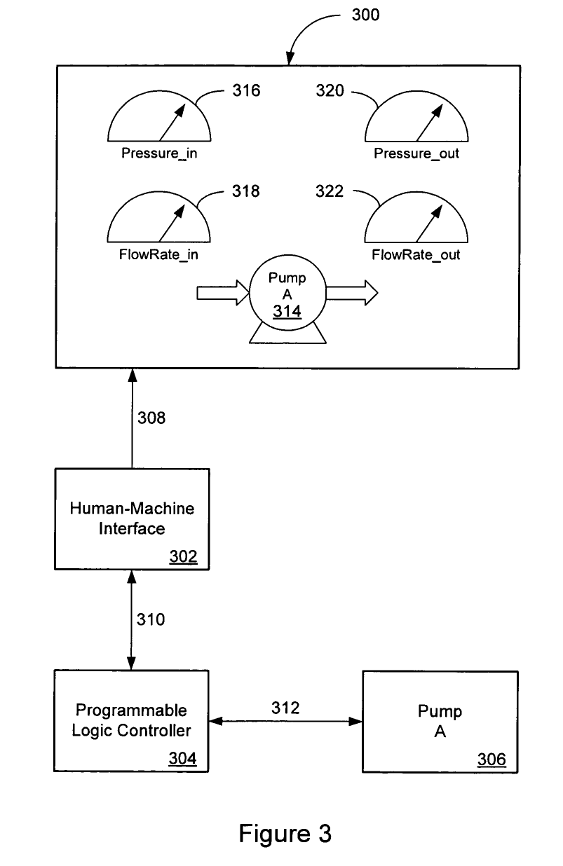

FIG. 3 is a block diagram of an automation system according to an embodiment of the invention. In this example embodiment of the invention, a pump labeled “A” 306 is controlled by a programmable logic controller (PLC) 304. The PLC 304 is coupled with a human-machine interface (HMI) 302, and the HMI 302 is configured to drive a display 300. The display 300 includes a graphical representation of pump A 314, along with graphical representations of the pumps input pressure 316, output pressure 320, input flow rate 318, and output flow rate 322. The PLC 304 is configured to control the pump 306, and also to receive data from the pump 306 through an electrical connection 312. The PLC 304 also sends data to the HMI 302 through another electrical connection 310, and receives control commands from the HMI 302 through the same connection. The HMI 302 sends data to the display 300 through another electrical connection 308. Those of skill in the art will recognize that this is simply one example embodiment of the invention, other embodiments may use other methods of communication between the elements, and may also use completely different graphical (or non-graphical) display elements all within the scope of the present invention. For example, some embodiments may use wireless, optical, or other communication methods in place of the electrical connections shown in this example embodiment.

The PLC 304 contains control configuration data related to the pump 306 which it controls. This configuration data may take a wide variety of formats all within the scope of the present invention. Typically, this configuration data is used to configure the PLC 304 with respect to what control parameters it sends to the pump 306, and to what monitoring parameters it receives from the pump 306. Likewise, the HMI contains visualization configuration data related to the pump 306. The HMI is configured to display monitoring parameters from the pump 306, and to provide a user interface allowing a user to control the pump 306 through the display 300 or other input device to the HMI 302.

If a new parameter, such as temperature, is available at the pump, the control configuration data and the visualization configuration data must be updated to take advantage of this new parameter. The visualization configuration data may take the form of a software object representing the pump 306. This software object would control how the visualization system graphically represents the pump 306 and the data received from the pump 306. The software object also describes how a user may interface with the HMI 302 in order to control the pump 306. For example, a user may be allowed to set the speed of the pump through the HMI 302. This speed data would then be communicated from the HMI 302 to the PLC 304 in a format recognized by both computer systems, and then the PLC 304 would set the speed of the pump 306 through the electrical connection 312 to the pump 306. If a new parameter is to be added to this example system, the configuration data in both the HMI 302 and the PLC 304 must be updated to include this new parameter. If the visualization configuration data and the control configuration data do not implement the new parameter in the same way, they will not be able to communicate the new data. Thus, by receiving a single software object containing this updated machine configuration data, and then creating separate visualization configuration data, and control configuration data from this single software object, mismatch errors may be greatly reduced.

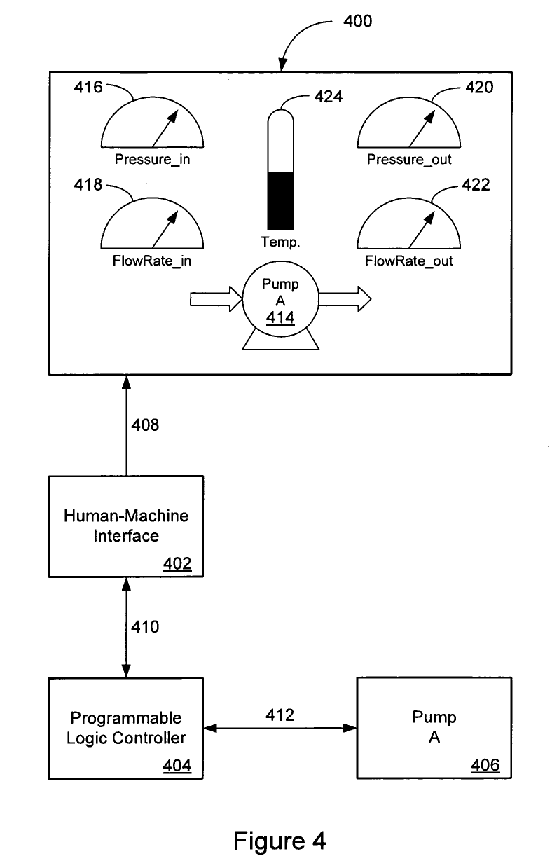

FIG. 4 is a block diagram of an automation system according to an embodiment of the invention. This example shows the system of FIG. 3 after a temperature parameter has been added to the HMI and control configurations. In this example embodiment of the invention, a pump labeled “A” 406 is controlled by a programmable logic controller (PLC) 404. The PLC 404 is coupled with a human-machine interface (HMI) 402, and the HMI 402 is configured to drive a display 400. The display 400 includes a graphical representation of pump A 414, along with graphical representations of the pumps input pressure 416, output pressure 420, input flow rate 418, output flow rate 422, and temperature 424. The PLC 404 is configured to control the pump 406, and also to receive data from the pump 406 through an electrical connection 412. The PLC 404 also sends data to the HMI 402 through another electrical connection 410, and receives control commands from the HMI 402 through the same connection. The HMI 402 sends data to the display 400 through another electrical connection 408.

The PLC 404 contains control configuration data related to the pump 406 which it controls. This configuration data may take a wide variety of formats all within the scope of the present invention. Typically, this configuration data is used to configure the PLC 404 with respect to what control parameters it sends to the pump 406, and to what monitoring parameters it receives from the pump 406. Likewise, the HMI contains visualization configuration data related to the pump 406. The HMI is configured to display monitoring parameters from the pump 406, and to provide a user interface allowing a user to control the pump 406 through the display 400 or other input device to the HMI 402.

In this example embodiment of the present invention, a single software object has been processed resulting in a new visualization software object, and a new control software object. The visualization software object has been sent to the HMI 402 where it now includes a graphical representation of the temperature 424 on the display 400. The control software object has been sent to the PLC 404 where it now has the ability to receive temperature data from the pump 406 and send this data to the HMI 402. Since this update proceeded automatically from the receipt of the single software object containing the updated machine configuration information, the likelihood of errors in the visualization software object and the control software object has been reduced.

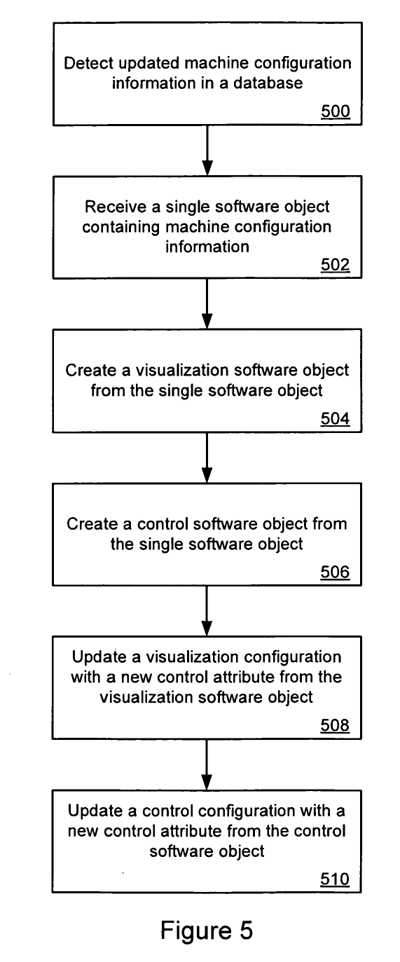

FIG. 5 is a flowchart of a method for updating an automation system according to an embodiment of the invention. In an operation 500, updated machine configuration information is detected in a database. This machine configuration information takes the form of a single software object. Those of ordinary skill in the art will recognize that there are a wide variety of methods and structures available for use in the creation of a single software object containing updated machine configuration information, all within the scope of the present invention. When the object is updated or created by a user, the method detects the modified file in a computer database, and reads the file in preparation for updating the automation system. In an operation 502, the single software object containing machine configuration information is received. This software object contains sufficient configuration information such that a visualization software object and a control software object may be generated. In an operation 504, a visualization software object is created from the single software object. Those of ordinary skill in the art will recognize that there are a wide variety of methods and structures available for the creation of a visualization software object containing visualization configuration data capable of configuring a visualization system, all within the scope of the present invention. In an operation 506, a control software object is created from the single software object. Those of ordinary skill in the art will recognize that there are a wide variety of methods and structures available for the creation of a control software object containing control configuration data capable of configuring a control system, all within the scope of the present invention. In an operation 508, a visualization configuration is updated with a new control attribute from the visualization software object. In an operation 510, a control configuration is updated with a new control attribute from the control software object.

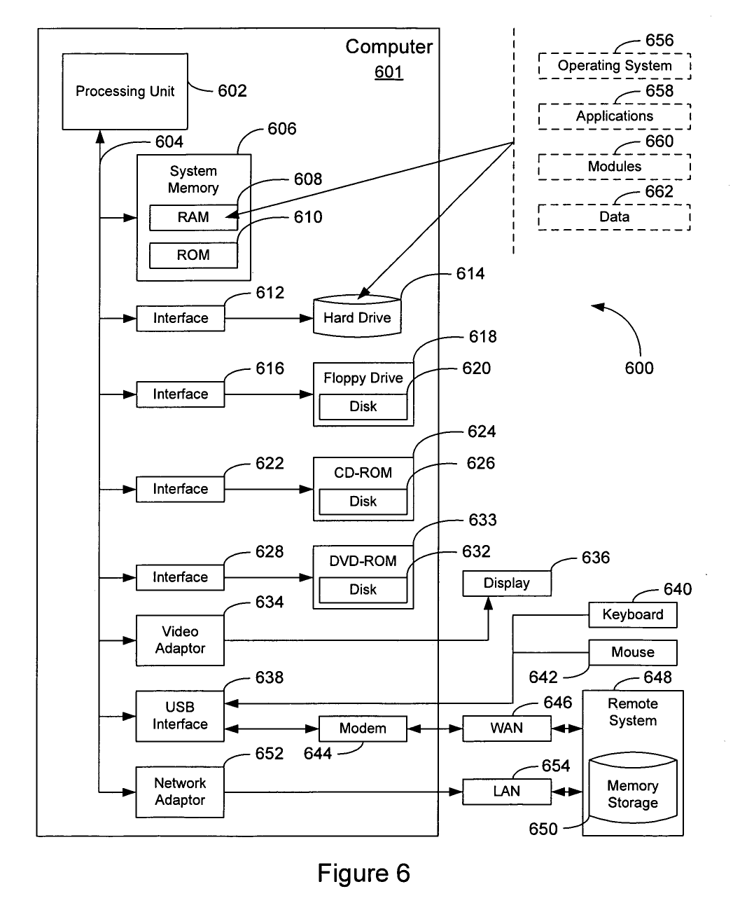

FIG. 6 is a block diagram illustrating a computer system in an embodiment of the invention. Computer system 600 includes a computer 601 which includes a processing unit 602, a system memory 606, and a system bus 604 that couples various system components including the system memory 606 to the processing unit 602. The processing unit may be any of a wide variety of processors or logic circuits, including the Intel X86 series, Pentium, Itanium, and other devices from a wide variety of vendors. The processing unit 602 may include a single processor, a dual-core processor, a quad-core processor or any other configuration of processors, all within the scope of the present invention. Computer 601 could be comprised of a programmed general-purpose computer, although those skilled in the art will appreciate that programmable or special purpose circuitry and equipment may be used. Computer system 600 may be distributed among multiple devices that together comprise elements 602-662.

Those of skill in the art will recognize that there are a wide variety of system bus 604 architectures, such as PCI, VESA, Microchannel, ISA, and EISA, available for use within the computer 601, and multiple system buses may be used within the computer 601, all within the scope of the present invention. The system memory 606 includes random access memory (RAM) 608, and read only memory (ROM) 610. The system ROM 610 may include a basic input/output system (BIOS), which contains low-level routines used in transferring data between different elements within the computer, particularly during start-up of the computer. The system memory 606 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the system memory 606 may incorporate electronic, magnetic, optical, and/or other types of storage media. Note that the system memory 606 can have a distributed architecture, where various components are situated remote from one another, but can be accessed by the processing unit 602.

The processing unit 602 receives software instructions from the system memory 606 or other storage elements and executes these instructions directing the processing unit 602 to operate in a method as described herein. These software instructions may include an operating system 656, applications 658, modules 660, utilities, drivers, networking software, and data 662. Software may comprise firmware, or some other form of machine-readable processing instructions.

The computer 601 also includes a hard drive 614 coupled to the system bus 604 through a hard drive interface 612, a floppy drive 618 containing a floppy disk 620 coupled to the system bus 604 through a floppy drive interface 616, a CD-ROM drive 624 containing a CD-ROM disk 626 coupled to the system bus 604 through a CD-ROM drive interface 622, and a DVD-ROM drive 633 containing a DVD-ROM disk 632 coupled to the system bus 604 through a DVD-ROM drive interface 628. Those of skill in the art will recognize that there are a wide variety of other storage elements, such as flash memory cards and tape drives, available for inclusion in a computer 601, which may be coupled to the system bus 604 through a wide variety of interfaces, all within the scope of the present invention. Also, these storage elements may be distributed among multiple devices, as shown here, and also may situated remote from each other, but can be accessed by the processing unit 602.

The computer 601 also includes a video adaptor 634 configured to drive a display 636, and a universal serial bus (USB) interface 638 configured to receive user inputs through a keyboard 640 and a mouse 642. Other user interfaces could comprise a voice recognition interface, microphone and speakers, graphical display, touch screen, game pad, scanner, printer, or some other type of user device. These user interfaces may be distributed among multiple user devices. The USB interface 638 is also configured to interface with a modem 644 allowing communication with a remote system 6048 through a wide area network (WAN) 646, such as the internet.

The computer 601 further includes a network adaptor 652 configured to communicate to a remote system 648 through a local area network (LAN) 645. Those of skill in the art will recognize that there are a wide variety of network adaptors 652 and network configurations available to allow communication with remote systems 648 all within the scope of the present invention. For example, networks may include Ethernet connections or wireless connections. Networks may be local to a single office or site, or may be as broad and inclusive as the internet or usenet. Remote systems 648 may include memory storage 650 in a very wide variety of configurations, all within the scope of the present invention.

In this example embodiment of the present invention, the software instructions may be configured to cause the processing unit 602 to execute the operations of the methods illustrated in FIGS. 1 through 5. The system memory 606 and storage devices may be configured to store the configuration model 104, visualization object 108, and control object 114. In such a configuration, the computer 601 is acting as the control layer interface 106 shown in FIG. 1, and the memory storage 650 within the remote system 648 contains the configuration models 104 shown in FIG. 1.

One should note that the flowcharts included herein show the architecture, functionality, and/or operation of a possible implementation of software. In this regard, each block can be interpreted to represent a module, segment, or portion of code, which comprises one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

One should note that any of the programs listed herein, which can include an ordered listing of executable instructions for implementing logical functions (such as depicted in the flowcharts), can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, or device. More specific examples (a nonexhaustive list) of the computer-readable medium could include an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). In addition, the scope of the certain embodiments of this disclosure can include embodying the functionality described in logic embodied in hardware or software-configured mediums.

It should be emphasized that the above-described embodiments are merely possible examples of implementations, merely set forth for a clear understanding of the principles of this disclosure. Many variations and modifications may be made to the above-described embodiments without departing substantially from the spirit and principles of the disclosure. All such modifications and variations are intended to be included herein within the scope of this disclosure.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method for updating control and visualization configurations in an industrial automation environment, comprising:
receiving a single software object containing machine configuration information related to a new machine attribute;
updating a visualization configuration with a new visualization attribute corresponding to the new machine attribute; and
updating a control configuration with a new control attribute corresponding to the new machine attribute.

2. The method of claim 1,
wherein a control system executes the control configuration to control a machine.

3. The method of claim 1,
wherein a visualization system executes the visualization configuration to display machine attribute data.

4. The method of claim 1,
wherein a visualization system executes the visualization configuration to graphically model a machine.

5. The method of claim 1, further comprising:
automatically detecting recently modified or new machine configuration information in a database of software objects.

6. The method of claim 1, further comprising:
creating a visualization software object containing the new visualization attribute from the single software object; and
creating a control software object containing the new control attribute from the single software object.

7. The method of claim 1, wherein the visualization system is a human-machine interface (HMI).

8. The method of claim 1,
wherein the control computer is a programmable logic controller (PLC).

9. A computer system, comprising:
a storage system containing software; and
a processing system coupled to the storage system;
wherein the processing system is instructed by the software to:
receive a single software object containing machine configuration information related to a new machine attribute;
update a visualization configuration with a new visualization attribute corresponding to the new machine attribute; and
update a control configuration with a new control attribute corresponding to the new machine attribute.

10. The computer system of claim 9, further comprising:
a control system configured to execute the control configuration to control a machine.

11. The computer system of claim 9, further comprising:
a visualization system configured to execute the visualization configuration to display machine attribute data.

12. The computer system of claim 9, further comprising:
a visualization system configured to execute the visualization configuration to graphically model a machine.

13. The computer system of claim 9,
wherein the processing system is also instructed by the software to:
automatically detect recently modified or new machine configuration information in a database of software objects.

14. The computer system of claim 9,
wherein the processing system is also instructed by the software to:
creating a visualization software object containing the new visualization attribute from the single software object; and
creating a control software object containing the new control attribute from the single software object.

15. A computer-readable medium of instructions for displaying automation data in a computer system, the instructions comprising:
receiving a single software object containing machine configuration information related to a new machine attribute;
updating a visualization configuration with a new visualization attribute corresponding to the new machine attribute; and
updating a control configuration with a new control attribute corresponding to the new machine attribute.

16. The computer-readable medium of claim 15,
wherein a control system executes the control configuration to control a machine.

17. The computer-readable medium of claim 15,
wherein a visualization system executes the visualization configuration to display machine attribute data.

18. The computer-readable medium of claim 15,
wherein a visualization system executes the visualization configuration to graphically model a machine.

19. The computer-readable medium of claim 15, the instructions further comprising:
automatically detecting recently modified or new machine configuration information in a database of software objects.

20. The computer-readable medium of claim 15, the instructions further comprising:
creating a visualization software object containing the new visualization attribute from the single software object; and
creating a control software object containing the new control attribute from the single software object.
